(19) United States
(12) Patent Application Publication
(10) Pub. No.: US 2020/0375376 A1
(43) Pub. Date: Dec. 3, 2020

(54) HANGING SYSTEM FOR STORAGE AND DISPLAY OF ARTWORK

(71) Applicant: Christian L. Gayden, West Palm Beach, FL (US)

(72) Inventor: Christian L. Gayden, West Palm Beach, FL (US)

(21) Appl. No.: 16/430,006

(22) Filed: Jun. 3, 2019

(51) Int. Cl. A47F 7/14; B44C 7/02; F16M 13/02; A47F 3/00; E04B 2/82

(52) U.S. Cl. CPC A47F 7/143; B44C 7/02; E04B 2/827; A47F 3/002; F16M 13/02

(57) ABSTRACT

The invention involves a system for storage and display of artworks. The system includes at least one panel assembly that is moveably mounted from above on a pair of rails so that the panel hangs from the rails. The panel assembly includes a frame supporting perforated metal to allow artwork, such as paintings, to be hung adjacent to the panel from their original hanging mount. A plurality of the sliding panels may be positioned in a parallel spaced manner to allow the artworks to be closely positioned with respect to each other. Security walls may be positioned in close proximity to the panels when in a storage position to prevent unwanted access to the artwork. Viewing the art requires the panels to be pulled out one at a time to view the art on that panel.

### FIELD OF INVENTION

The present invention generally relates to the storage of hanging art and, more particularly, to a system that allows numerous pieces of art to be stored and displayed in a relatively small area.

### BACKGROUND INFORMATION

Art conservation is a profession devoted to the preservation of cultural heritage for the future. Many cultural works are sensitive to environmental conditions such as temperature, humidity, and exposure to light. They must be protected in a controlled environment where such variables are maintained within a range of damage-limiting levels. A conservator is typically employed to do so. The traditional definition of the role of the conservator involves the examination, conservation, and preservation of cultural heritage using “any methods that prove effective in keeping that property in as close to its original condition as possible, for as long as possible.” However, today the definition of the role of conservator has widened, and would more accurately be described as that of an ethical stewardship. The conservator applies some simple ethical guidelines, such as minimal intervention, the use of appropriate materials and methods that aim to be reversible to reduce possible problems with future treatment, investigation, and full documentation of all work undertaken. In order to maintain the ethical guidelines set forth, a conservator should employ methods and materials to ensure that the framed artwork is protected from harmful environmental factors, while not compromising its condition or integrity. Furthermore, no process used by the conservator should be irreversible. Additionally, the conservator must take into account several environmental factors such as light, heat, humidity, moisture, dirt and dust, as they can be harmful to artwork. Any amount of light is damaging to artwork over time. Colors will fade as a result of exposure to ultraviolet rays from natural and fluorescent sources alike. Paper absorbs high-energy photons which, through a chemical reaction, break down the paper over time and cause it to become brittle. Framed artwork should be kept away from sources of heat or water. Warm and moist conditions invite the growth of mold and bacteria. Moisture in the form of condensation can collect inside the framing if subjected to radical changes in temperature or humidity. Pollution in the atmosphere can combine with moisture in the air to form acids that will cause damage to works on paper. In addition, framed artwork should be stored upright, preferably in a hanging position; much like art is displayed in a museum and the manner in which the art was constructed to be supported.

It is also desirable to view stored art periodically. Thus, any art storage system should provide access to view the artwork without the need to remove cumbersome covers, boxes, crates or the like. It is also desirable to have art displays that allow the art to be simply pulled out for display or examination in groups, whereby one art display can be positioned behind or in front of another. In this manner, numerous pieces of art may be displayed to a group sitting or standing in a single position.

Finally, there are ergonomic needs that an art storage system must satisfy in order to achieve acceptance by the end user. The system must allow for artworks of various sizes to be secured to the storage system easily and quickly, using minimal hardware and requiring a minimal number of tools. Further, the system should not require excessive strength to move the assembled storage in order to view or examine the artwork. Moreover, the system must assemble together in such a way so as not to detract from the aesthetic appearance of the artwork itself.

Thus, the present invention provides an art storage system which overcomes the disadvantages of prior art storage systems. The art storage system of the present invention not only provides for relative ease in assembly and movement, it also permits various sized artwork to be secured to the art storage system without the need to reconfigure the art storage system.

### SUMMARY OF THE INVENTION

Briefly, the invention involves a system for storage and display of artworks. The system includes at least one panel assembly that is moveably mounted from above on a pair of rails so that the panel hangs from the rails. The panel assembly includes a frame supporting perforated metal to allow artworks, such as paintings, to be hung adjacent to the panel from their original hanging mount. A plurality of the sliding panels may be positioned in a parallel spaced manner to allow the artworks to be closely positioned with respect to each other. Security walls may be positioned in close proximity to the panels when in a storage position to prevent unwanted access to the artwork. Viewing the art requires the panels to be pulled out one at a time to view the art on that panel.

Accordingly, it is an objective of the present invention to provide an artwork storage system.

It is a further objective of the present invention to provide an artwork storage system that utilizes sliding panels suspended from above to eliminate floor tracking.

It is yet a further objective of the present invention to provide a unique track system to reduce sway and unwanted movement in the sliding panels as they are stored or moved.

It is another objective of the instant invention to provide a remote controlled artwork display system.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIG. 1 is a front view of one embodiment of the present invention;

FIG. 2A is a front view of an alternative embodiment of the present invention;

FIG. 2B is a partial front view of another embodiment;

FIG. 3 is a partial side view taken along lines 3-3 of FIG. 1 illustrating the unique wheel and track system for the art display system;

FIG. 4 is a partial side view illustrating one embodiment for connecting hanging artwork to the sliding panel;

FIG. 5 is a partial side view illustrating one embodiment for attaching shelves to the sliding panels;

FIG. 6 is a partial side view illustrating a bump stop for softening the impact of the sliding panels reaching the end of the track;

FIG. 7 is a partial perspective view illustrating a plurality of panel assemblies which may be enclosed to provide safety and a desired environment for the artwork;

FIG. 8 is a side view of one embodiment of the panel assembly;

FIG. 9 is a partial section view taken along lines 9-9 of FIG. 8 illustrating one construction for the frame assembly;

FIG. 10 is a partial section view taken along lines 10-10 of FIG. 8 illustrating a perforated center panel construction;

FIG. 11 is an end view of one embodiment of the rail member assembly;

FIG. 12 is a partial side view of the rail mounting assembly;

FIG. 13 is a partial side view of an alternative rail mounting assembly;

FIG. 14 is a partial side view of a support assembly for supporting the hanging system for storage and display of artwork;

FIG. 15 is a partial view taken along lines 15-15 of FIG. 14; and

FIG. 16 is a perspective view illustrating one embodiment of the hanging system for storage and display of artwork.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

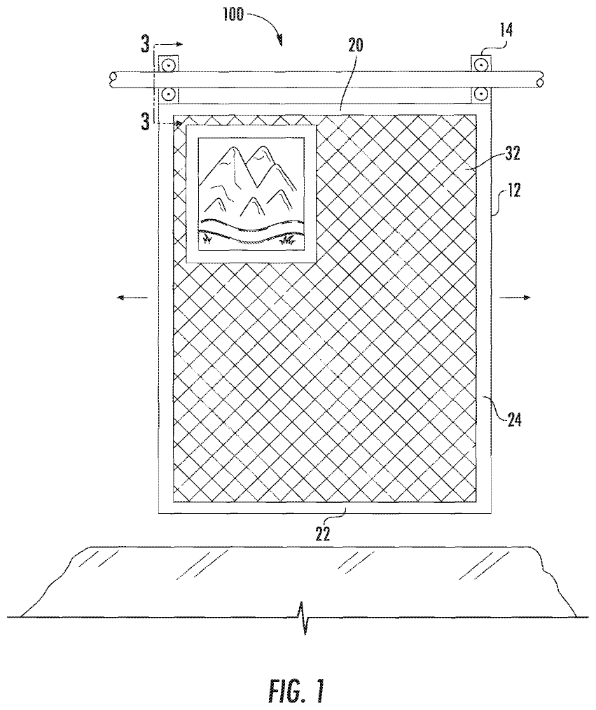

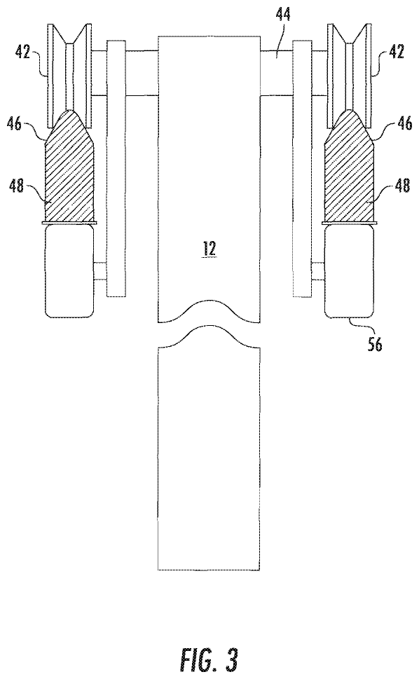

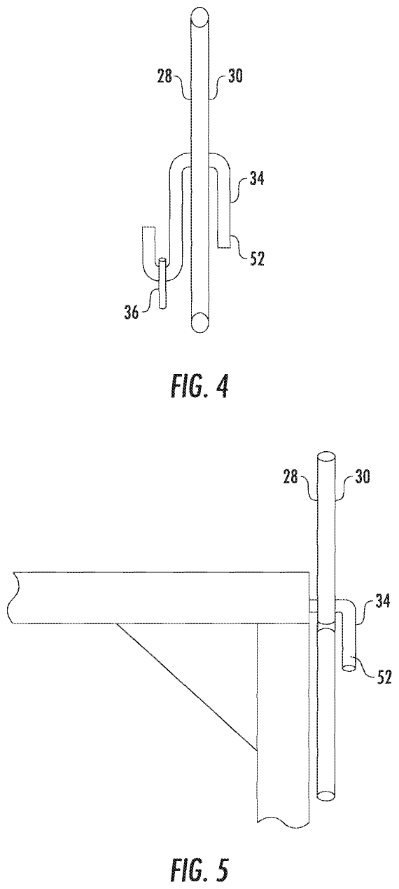

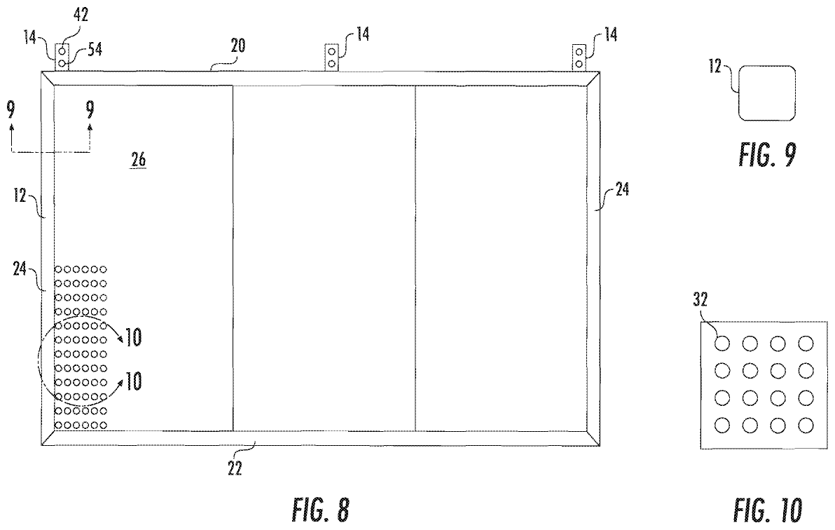

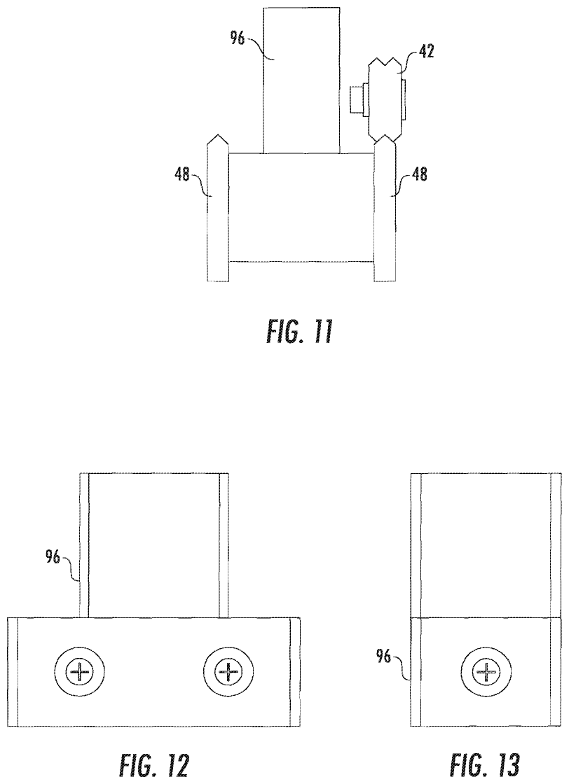

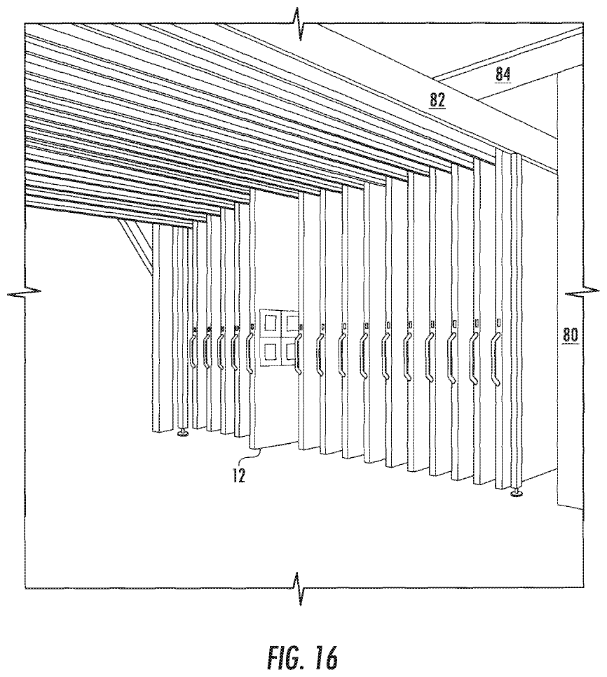

Referring generally to FIGS. 1-16, a hanging system for storage and display of artwork 100 is illustrated. The hanging art storage system 100 includes a frame assembly 12, a roller assembly 14, and may include an enclosure 16 and door 18. The frame assembly 12 is preferably substantially rectangular in shape; substantially meaning within manufacturing guidelines. The frame assembly 12, includes a top member 20, a bottom member 22 and a pair of side members 24 surrounding and retaining a center panel 26. The center panel 26 is perforated, having a first side surface 28 and a second side surface 30. The perforations 32 may be in many different forms without departing from the scope of the invention, and thus include woven wire, peg board and the like; the perforations 32 extending through the first side surface 28 to the second side surface 30, each said perforation sized and shaped to accept passage of a first portion of a hook member 34, each hook member being constructed and arranged to cooperate with a hanging support member 36 on a painting 38 to cause the painting to be supported generally parallel and adjacent to one of said first or said second side surfaces 28, 30. It is also contemplated to utilize two center panels 26 spaced apart so that a back portion 52 of the hook members 34 are not visible from the opposite side of the center panels 26 for an aesthetically pleasing appearance for display of the art.

A top portion of the frame assembly 12 includes a roller assembly 14 having a plurality of rollers 42. The rollers 42 are positioned on opposite sides of the frame assembly 12 to prevent sway of the frame assembly during movement or storage. The rollers 42 may be spaced further apart to provide stability as needed to stabilize the artworks during movement and storage. An axle member 44 may extend through or be supported by the frame assembly 12. The rollers 42 are constructed and arranged to roll on a top surface 46 of a pair of rail members 48 positioned on opposite sides of the frame assembly 12 so that a bottom surface 50 of said frame assembly 12 is supported above a ground surface. It should also be noted that the rollers 42 and the rail members, or rails, 48 may be reversed without departing from the scope of the invention. In this embodiment, the rails 48 would be positioned on both sides of the frame assembly 12, and the rollers 42 would be placed in fixed positions for the rails 48 to roll thereupon. In either embodiment, a top surface 46 of the rail members 48 includes a contour for causing the plurality of rollers 42 to be desirably positioned by the contour on the rail members 48. In a most preferred embodiment, one or both rail members 48 each include an inverted V-shaped top surface 46, and each of the top rollers 42 include a conjugate V-shaped outer diameter for cooperation with the rail members 48 to center the roller upon the rail. It should be noted that contoured shapes on the top surface of the rails may include shapes other than the V-shape that are suitable for locating or centering the rollers and may be utilized without departing from the scope of the invention. Each roller assembly 14 also preferably includes a pair of lower rollers 54; each of said pair of lower rollers 54 positioned to cooperate with a respective bottom surface 58 of the pair of rail members 48 to prevent sway and lift of the panel assembly 12 during movement or storage. In a most preferred embodiment, the lower rollers 54 include a radiused contact surface 56. The radiused contact surface reduces friction and allows for misalignment between the upper rollers 42 and the lower rollers 54.

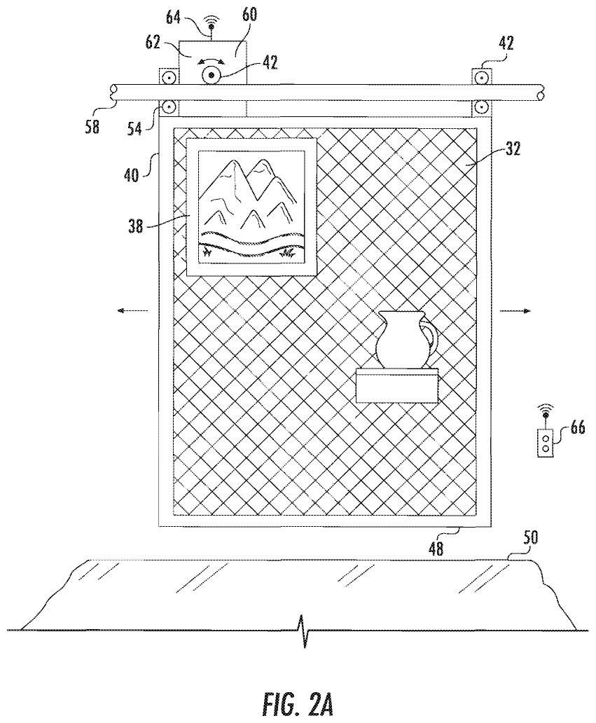

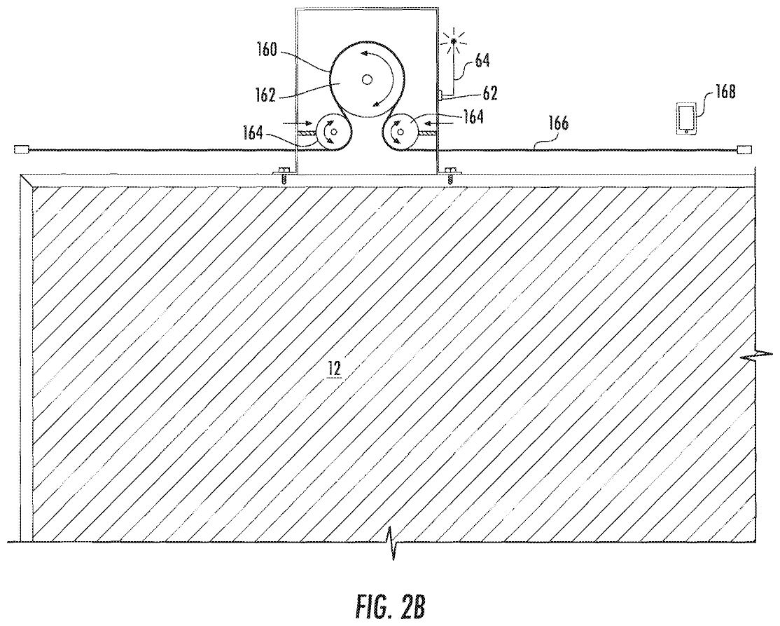

Referring generally to the Figs., and particularly to FIGS. 2A and 2B. In at least one embodiment, at least one top roller 42 may be powered to cause controlled rotation of the top roller and thus the panel assembly 12. In this embodiment, an electric motor 60 is mechanically linked to the upper roller 42 to cause controlled rotation of the roller in either direction at the control of an operator. Gear drives, belt drives, frequency drives and the like may be utilized to control the speed and torque supplied to the powered roller(s). The electric motor 60 may be radio controlled, having a receiver 62 and an antenna 64 to receive electrical signals from a hand held remote control 66, cell phone or the like. In this manner, a user could control the opening and closing of multiple sliding art displays from a remote position for personal viewing or for display to an audience. FIG. 2B illustrates an alternative embodiment for powering the panel assembly 12. This embodiment includes a servo motor 160 driving a pulley 162. The servo motor 160 and pulley 162 are positioned in proximity to a pair of spring loaded pulleys 164 so that a cable 166 extends through the pulleys in a tortuous path to maintain tension on the cable 166. The electric servo motor 160 may be radio controlled, having a receiver 62 and an antenna 64 to receive electrical signals from a hand held remote control 66, cell phone or the like. In this manner, a user could control the opening and closing of multiple sliding art displays from a remote position for personal viewing or for display to an audience.

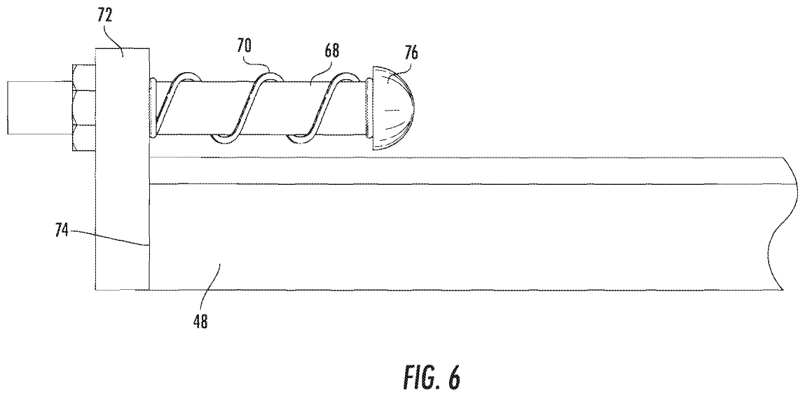

Referring to FIG. 6, a distal end 74 of each rail member 48 includes a positive stop member 72 to prevent the panel assembly 12 from movement past the distal end 74 of the rail members 48. In some embodiments, the positive stop member 72 includes a spring member 70 positioned about a sliding stop member 68 to provide a cushion to the frame assembly 12 when approaching and contacting the stop member 68. The sliding stop member 68 may additionally include a rubber bumper 76 to reduce noise and soften the contact between the frame assembly 12 and the sliding stop member 68.

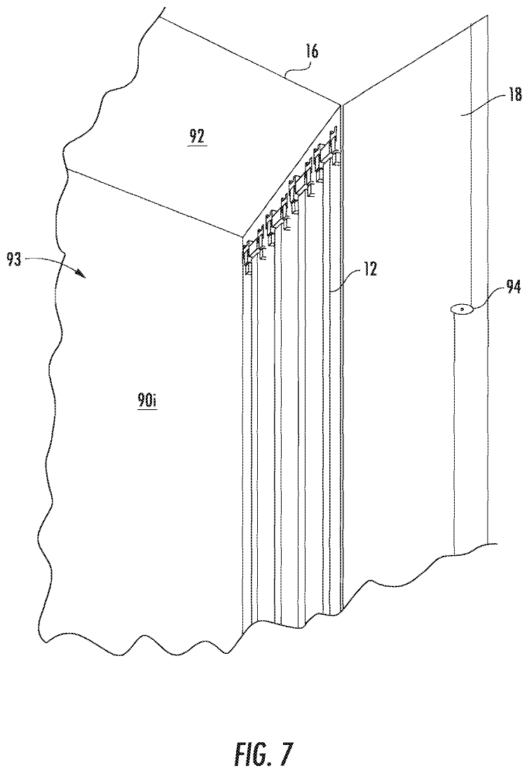

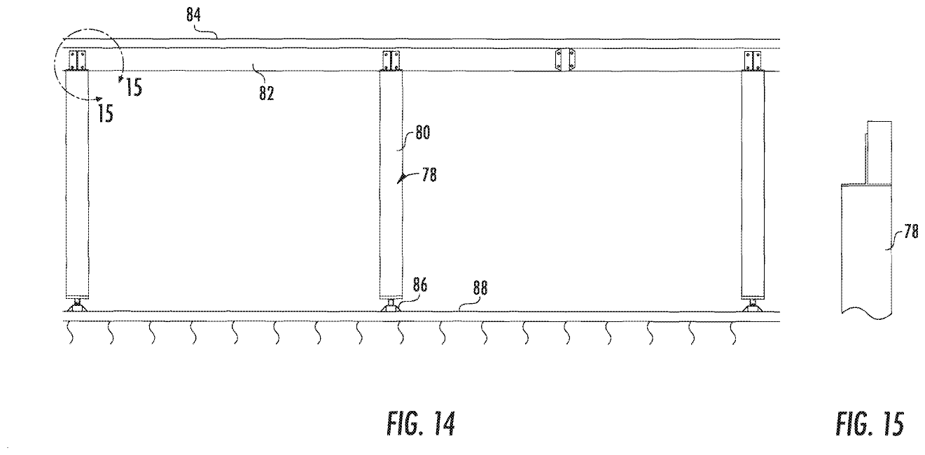

Referring to FIGS. 7-16, various embodiments of the present system are illustrated having a plurality of the frame assemblies 12 arranged in a side by side parallel arrangement. FIGS. 14 and 15 illustrate a side support assembly 78 including vertical members 80, horizontal members 82, and cross beams 84. The vertical members 80 include levelers 86 on a bottom portion thereof for use when placed upon a hard surface. A top portion of the vertical members 80 are secured to horizontal members 82 that connect the vertical members 80 to create a side support assembly 78. Two side support assemblies 78 are connected with cross beams 84 to create a parallelepiped shaped structure from which the frame assemblies 12 are supported above the hard floor surface. Rail support assemblies 96 are constructed and arranged for attachment to the cross beams 84 to support the rail members 48 from above. In this manner, dirt, debris and the like, which can get into floor tracks is avoided to prevent jostling of the artwork during movement of the frame assemblies. The width of the cross beams 84 determine the number of frame assemblies that can be supported in a side by side arrangement. In at least one embodiment, the support assemblies 96 and the cross beams 84 can be enclosed with side walls 90, top walls 92 and a hinged door 18. The hinged door 18 may include a lock 94, which may be one of various types, and the walls and door may be constructed to prevent theft of the artwork by being constructed as safe walls, as is known in the art. In another embodiment, the enclosure 93 can be utilized to maintain a desired atmosphere for the artwork, whereby moisture, air temperature and the like are controlled within the enclosure for preservation of the art. The frame assemblies 12 may be spaced within the enclosure to prevent a would-be thief from passing between the panels, and the panels may include a lock to prevent their movement when locked in position.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objects and obtain the ends and advantages mentioned, as well as those inherent therein. Any compounds, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A hanging system for storage and display of artwork comprising:
a frame assembly, said frame assembly surrounding and retaining a center panel, said center panel being perforated, having a first side surface and a second side surface, said perforations extending through said first side surface to said second side surface, each said perforation sized and shaped to accept passage of a first portion of a hook member, each said hook member constructed and arranged to cooperate with a hanging support member on a painting to cause said painting to be supported generally parallel and adjacent to one of said first or said second side surfaces,
a top portion of said frame assembly including a roller assembly having a plurality of rollers, said rollers positioned on opposite sides of said frame to prevent sway of said frame assembly, said rollers constructed and arranged to roll on a top surface of a pair of rail members positioned on opposite sides of said frame assembly so that a bottom surface of said frame assembly is supported above a ground surface.

2. The hanging system for storage and display of artwork of claim 1 including a plurality of said hanging systems for storage of artwork arranged in a side by side parallel arrangement.

3. The hanging system for storage and display of artwork of claim 1 wherein said frame assembly is substantially rectangular in shape, said frame having a top member, a bottom member and a pair of side members.

4. The hanging system for storage and display of artwork of claim 1 wherein a top surface of said rail members includes a contour for causing said plurality of rollers to be centered on said rail members.

5. The hanging system for storage and display of artwork of claim 4 wherein said pair of rail members each include an inverted V-shaped top surface, said plurality of rollers including a pair of top rollers positioned at opposite ends of said frame assembly, each of said pair of top rollers including a V-shaped outer diameter for cooperation with said rail members.

6. The hanging system for storage and display of artwork of claim 4 wherein each said roller assembly includes a pair of lower rollers, each of said pair of lower rollers positioned to cooperate with a respective bottom surface of said pair of rail members to prevent sway and lift of said panel assembly during movement or storage.

7. The hanging system for storage and display of artwork of claim 1 wherein a distal end of each said rail member includes a stop member to prevent said panel assembly from movement past said distal end of said rail members.

8. The hanging system for storage and display of artwork of claim 7 wherein said stop member includes a spring member to provide a cushion to the frame assembly when contacting said stop member.

9. The hanging system for storage and display of artwork of claim 5 wherein at least one said top roller is powered to cause controlled rotation of said top roller.

10. The hanging system for storage and display of artwork of claim 9 wherein said at least one powered top roller is powered by an electric motor.

11. The hanging system for storage and display of artwork of claim 10 wherein operation of said electric motor is remote controlled.

12. The hanging system for storage and display of artwork of claim 10 including a lock member for engaging a fixed member to prevent movement of said panel assembly.

13. The hanging system for storage and display of artwork of claim 10 including a wall assembly positioned adjacent and parallel to a front side of said panel assembly, said wall assembly positioned sufficiently close to said panel assembly to prevent access to art stored on said panel assembly.

14. The hanging system for storage and display of artwork of claim 13 including a second wall assembly positioned adjacent and parallel to a rear side of said panel assembly, said wall assembly positioned sufficiently close to said panel assembly to prevent access to art stored on said panel assembly.

15. The hanging system for storage and display of artwork of claim 14 including a door for enclosing said panel assembly.

16. The hanging system for storage and display of artwork of claim 15 including a controlled atmosphere within said side wall and said door to prevent deterioration of artwork secured to said panel assembly.
